(19) United States
(12) Patent Application Publication
(10) Pub. No.: US 2002/0072042 A1
(43) Pub. Date: Jun. 13, 2002

(54) Learning kit for three-dimensional play

(76) Inventor: Jong-Taik Ko, Seoul (KR)

Correspondence Address: ANDERSON KILL & OLICK, P.C., 1251 Avenue of the Americas, New York, NY, 10020, US

(21) Appl. No.: 09/770,866

(22) Filed: Jan. 26, 2001

(30) Foreign Application Priority Data
Dec. 13, 2000 (KR) 10-2000-0075732

(51) Int. Cl. G09B 19/00

(52) U.S. Cl. 434/259

(57) ABSTRACT

Provided is a learning kit for three-dimensional play, for cultivating hand-to-eye coordination in children by constructing the contents of fairly tales by three-dimensional articles. A learning kit body having a cubic effect is constructed by representing people, objects, animals, plants or insects appearing on fairly tales or novels, toward which the children have a friendly feeling, in a realistic way, by means of nonwoven fabric boards which are adhesive to each other. Learning is done by standing on the substrate provided in the learning kit body the three-dimensional articles independently formed in harmony with divergent forms displayed on the learning kit body in an upright state. Also, since learning articles are attached to or suspended on the learning kit body, the children use their eyes, brain and hands at the same time, the learning effect can be further enhanced through utilization of hand-to-eye coordination. Also, since the learning kit is formed of fabric materials, it is safe and can be conveniently used.

### BACKGROUND OF THE INVENTION

1. Field of the Invention

The present invention relates to a learning kit for three-dimensional play, for use in improvement of learning effect as well as brain development infants or children, and more particularly, to a learning kit for three-dimensional play for cultivating high ability to learn to cultivate children's hand-to-eye coordination through utilization of their visual, auditory and tactile senses at the same time, and to foster children interest in learning, by constructing educational contents in a realistic, three-dimensional manner using nonwoven fabric boards.

2. Description of the Related Art

As is known well, many learning kits adapted to stimulate brain development or cultivate a learning ability by instilling in infants or children their interest in learning, have been developed.

However, existing teaching aids used for cultivating in children the learning effect for letters, figures or pictures, are typically in the form of books or cards containing such educational information. In the traditional teaching aids, since children learn or are taught letters, figures and pictures displayed on a two-dimensional plane simply by their visual sense, their interest in learning may be spoiled. Various researches into children's learning have proved that learning by hands-on experiences using three-dimensional articles is a very effective method.

Existing teaching aids such as books or cards are mostly fabricated by thick, hard paper for preventing damage. Thus, in the event that a child happens to throw the book just for fun, the child's play mate may be struck on the head or eye by the edge of the book, so that he/she may be fatally wounded. Also, if the book or card is used for long or comes into contact with moisture or water, the book or card made of paper is easily worn out, resulting in shortening the life. Further, when the book or card becomes dirty, it cannot be washed.

### SUMMARY OF THE INVENTION

It is an object of the present invention to provide a learning kit for three-dimensional play, configured such that various objects, animals or plants appearing on fairy tales are constructed by realistic three-dimensional articles to make them acquainted with the development of the contents of the fairy tales as they directly move the three-dimensional articles, thereby evenly cultivating brain through utilization of visual, auditory and tactile senses, improving object recognition and memory owing to hand-to-eye coordination by utilization of visual, auditory and tactile senses, and increasing a learning effect by instilling interest for three-dimensional articles having a cubic effect.

To accomplish the above object of the present invention, there is provided a learning kit for three-dimensional play, having a display portion of displaying letters, figures, objects, animals, plants and insects for development of children's ability to learn and intelligence quotient, the learning kit including a foldable main body having a substrate formed by sewing two or more nonwoven fabric boards cut in predetermined shapes, and wall plates, connected with each other by being vertically mounted at the remaining edge, except a one-side edge, of the substrate with each other, the wall plate having a cubic effect by inserting a fiber between the nonwoven fabric boards cut in divergent shapes of animals, plants or insects and then sewing the same in two folds, and a plurality of three-dimensional article, being in harmony with various forms displayed on the wall plate, having a three-dimensional portion providing a cubic effect by sewing the articles of shapes of animals, plants or insects cut from the same nonwoven fabric board as the main body in two or more folds and inserting a fiber inside, and a stand, sewed to be leveled at the bottom portion of the three-dimensional portion, for support the same to erect on the substrate, the stand formed of the same nonwoven fabric board as the substrate.

The learning kit further includes learning articles containing shapes of letters, figures, animals, plants and insects formed of the same nonwoven fabric board as the substrate, and capable of being attached to or detached from the wall plate and substrate.

Also, the learning kit preferably includes a suspension means for suspending the learning articles on the wall plate of the main body, the suspension means, and the suspension means has a plurality of holes opened outward with respect to the wall plate, suspension pieces, inserted into the respective holes in an outwardly exposed state, for forming suspension units for suspending the learning articles, and suspension holes formed on the learning articles.

Further, each of the suspension pieces includes a rectangular body, formed of the same nonwoven fabric board as the main body, attachably inserted into the wall plate, a head, protruding outward from the holes of the wall plate to form the suspension unit, the head being long and having a narrow width at one side of the body, and a hanging projection, protruding toward either side of the head, spaced apart from the body, and latching the head to the hole, without falling into the hole.

Also, the learning kit may further include a display portion at the bottom of the stand of each of the three-dimensional articles, for displaying the three-dimensional article.

The substrate of the main body is preferably formed by at least two separate boards so as to be easily foldable.

Also, the nonwoven fabric boards are felt sheets, which are adhesive to each other.

According to the present invention, various objects, animals or plants appearing on fairy tales are constructed by realistic three-dimensional articles to make children acquainted with the development of the contents of the fairy tales as they directly move the three-dimensional articles, thereby evenly cultivating brain through utilization of visual, auditory and tactile senses, improving object recognition and memory owing to hand-to-eye coordination by utilization of visual, auditory and tactile senses, and increasing a learning effect by instilling interest for three-dimensional articles having a cubic effect.

Also, since the learning kit is fabricated by felt, it is safe and durable, without being damaged due to moisture or water. Also, when the learning kit becomes dirty, it can be easily washed for reuse.

### BRIEF DESCRIPTION OF THE DRAWINGS

The above object and advantages of the present invention will become more apparent by describing in detail a preferred embodiment thereof with reference to the attached drawings in which:

FIG. 1 is a perspective view of a learning kit for three-dimensional play according to an embodiment of the present invention;

FIG. 2 is a perspective view of FIG. 1 externally viewed;

FIG. 3 is an enlarged cross-sectional view, taken along the line I-I of FIG. 2;

FIG. 4 is an enlarged perspective view of a portion “A” shown FIG. 1;

FIG. 5A is an enlarged perspective view showing the bottom portion of a three-dimensional article shown in FIG. 1, and FIG. 5B is a cross-sectional view, taken along the line II-II of FIG. 5A;

FIG. 6 is a perspective view showing the folded state of the learning kit for three-dimensional play according to the present invention;

FIG. 7 is a perspective view of a learning kit for three-dimensional play according to another embodiment of the present invention; and

FIG. 8 is an enlarged cross-sectional view, taken along the line III-III of FIG. 7.

### DESCRIPTION OF THE PREFERRED EMBODIMENTS

A learning kit for three-dimensional play according to a preferred embodiment of the present invention will now be described in detail with reference to the accompanying drawings.

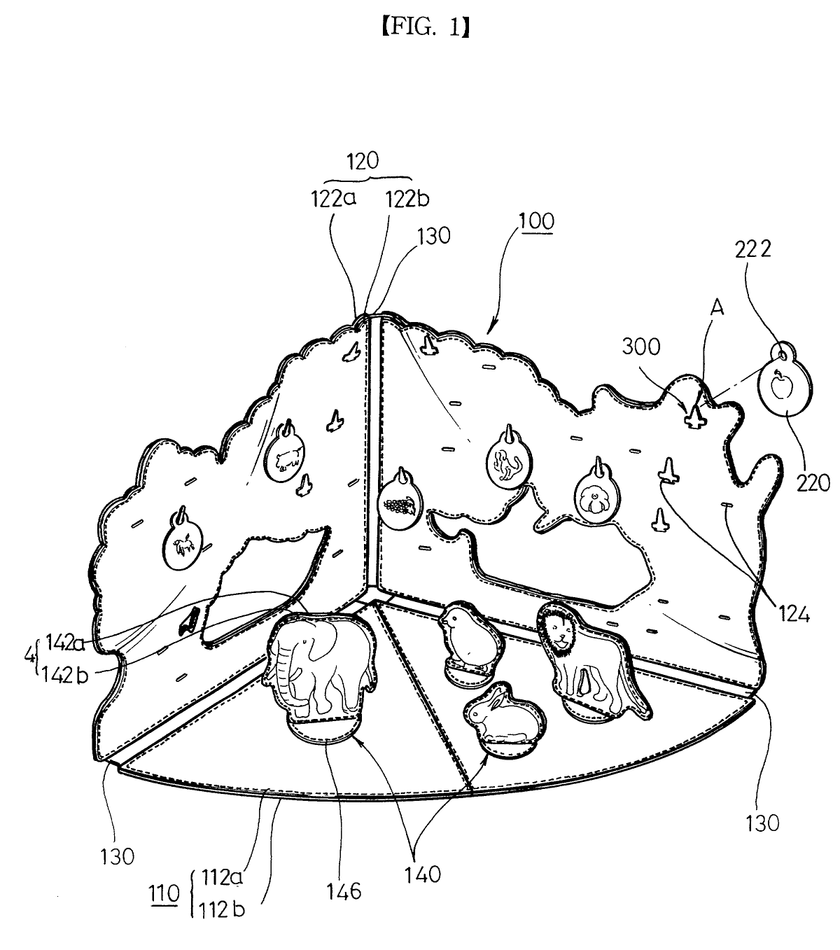

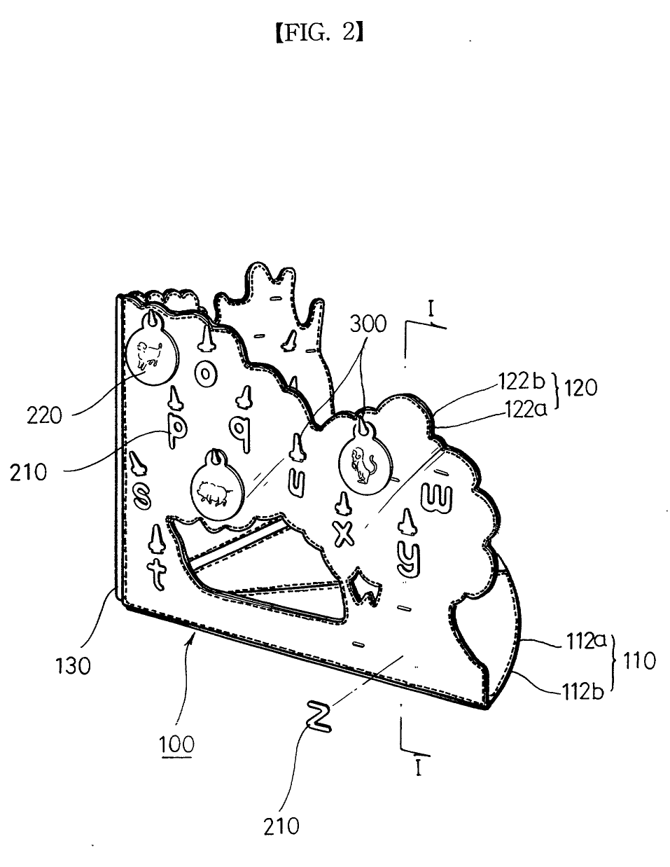

FIG. 1 is a perspective view of a learning kit for three-dimensional play according to an embodiment of the present invention, and FIG. 2 is a perspective view of FIG. 1 externally viewed.

As shown in the drawings, the learning kit for three-dimensional play according to an embodiment of the present invention includes a learning kit body 100 having letters, figures, objects, animals, plants, insects and so on, for cultivating children in their ability to learn and their intelligence quotient, formed in a three-dimensional manner. The learning kit body 100 includes a substrate 110 formed of felt, which is a kind of a nonwoven fabric having an adhesive property, and a wall plate 120.

First, the substrate 110 is formed by two nonwoven fabric boards 112a and 112b which are cut in an arbitrary shape and sewn using a sewing machine. In the present invention, the substrate 110 is formed of two separate boards, for easily folding the same to facilitate storage. However, the substrate 110b may be formed in a single body. Also, the substrate 110 may be formed of a single-fold nonwoven fabric panel 112a or 112b. However, in order to endow the substrate 110 with predetermined strength, the substrate 110 is preferably formed of two or more folds. Although it has been described and illustrated in this embodiment that the substrate 110 is formed fanwise by way of example, the substrate 110 may take any shape other than that shown in the drawing, including rectangular, circular or the like.

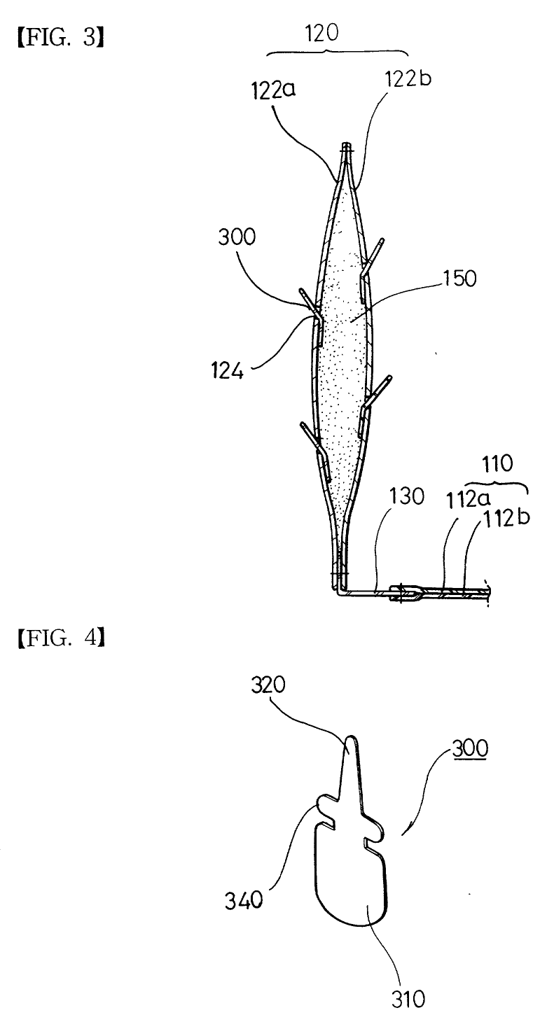

The remaining edge, except a one-side edge, of the substrate 110 are connected with each other by vertically mounting the wall plate 120 formed by sewing at least two nonwoven fabric boards 122a and 122b to attain a predetermined strength, like the substrate 110. The wall plate 120 is formed to have a cubic effect by inserting a filler (to later be described in detail with reference to FIG. 3), such as a fiber, between the nonwoven fabric boards 122a and 122b cut in divergent shapes of objects such as houses, animals, plants or insects toward which children have a friendly feeling and then sewing the same, unlike the substrate 110. Here, although the substrate 110 and the wall plate 120, and the wall plate 120 and another wall plate 120, can be connected by direct sewing, they are preferably connected by sewing using separately provided nonwoven fabric connecting boards 130, for working convenience.

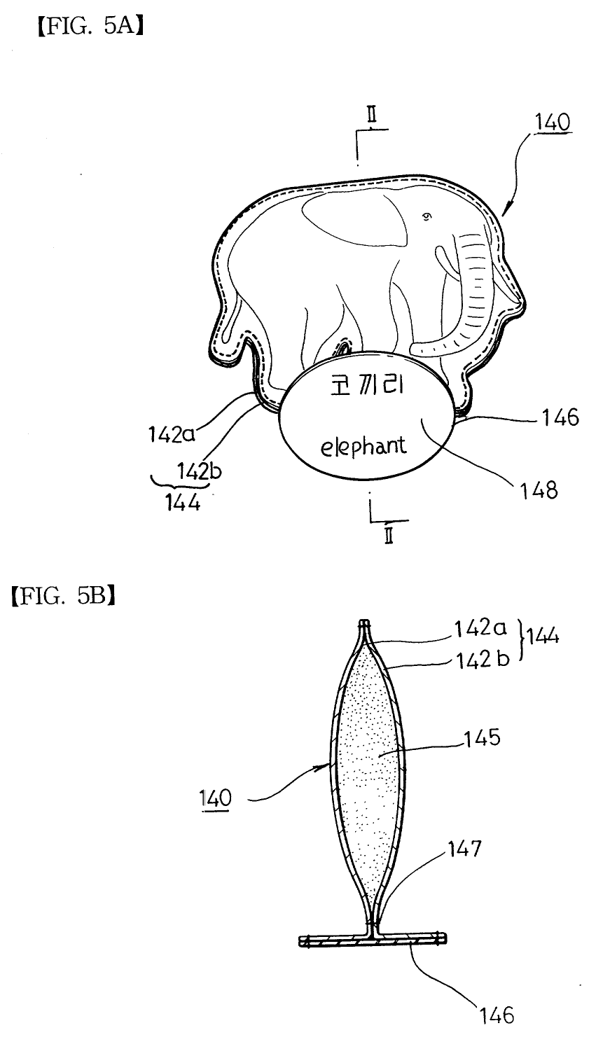

A plurality of three-dimensional articles 140 being in harmony with various forms displayed on the wall plate 120, are positioned on the substrate 110 of the learning kit body 100 in an upright state. The three-dimensional articles 140 can be freely moved to arbitrary positions on the substrate 110 by children. In this case, since the children select the three-dimensional articles 140 matching well with the forms displayed on the wall plate 120 at their discretion to move the same, educational effects of improving children's object recognition and memory can be attained. Since the three-dimensional articles 140 are formed of nonwoven fabric boards having adhesive properties, like the substrate 110, they adhere to each other when made to stand on the substrate 110, so that they can be securely erected. Also, the three-dimensional articles 140 are formed of the same nonwoven fabric boards as the learning kit body 100. In particular, a three-dimensional portion 144 having a cubic effect, fabricated such that the filler (to later be described with reference to FIG. 5) is inserted into the two nonwoven fabric boards 142a and 142b cut in divergent shapes of objects, animals, plants or insects, and then the fabric is sewed, gives children soft tactile feelings and a realistic, cubic effect. The thus-fabricated three-dimensional portion 144 has a stand 146 sewed to be leveled at its bottom portion, for support the same to erect on the substrate 110. The stand 146 is also formed of a nonwoven fabric board and is cut so as to have a predetermined width for securely standing the three-dimensional portion 144 to then be integrally formed with the boards 142a and 142b of the three-dimensional portion 144. The three-dimensional portion 144 is of the same structure in each of the respective three-dimensional articles 140, with only the represented shapes differed.

Card-shaped learning articles 210 and 220 formed of the same material as that of the wall plate 120 of the learning kit body 100, are provided on the wall plate 120 to allow children to acquire a great learning effect in recognition of letters or figures, shapes of animals and plants and other objects.

First, the first learning article 210 is formed by cutting the same nonwoven fabric board as the learning kit body 100 so as to have any one of shapes of letters, figures, objects, animals, plants, insects and the like. In this embodiment, a Korean word and the corresponding English word are displayed to represent an elephant by way of example.

The second learning article 220, unlike the first learning article 210, contains one of shapes of letters, figures, objects, animals, planes or insects and the corresponding name on a nonwoven fabric board cut in a predetermined pattern, i.e., a circular pattern. The shape represented on the second learning article 220 can be arbitrarily varied and changed. The second learning article 220 is preferably shaped such that children are motivated by a sense of curiosity. More preferably, the shape of the second learning article 220 corresponds to that of the wall plate 120 of the learning kit body 100 or the three-dimensional article 140. Since the learning articles 210 and 220 are made of the same material as that of the learning kit body 100, that is, nonwoven fabric having such a characteristic as a magic tape, they can be easily attached to or detached from the wall plate 120 of the learning kit body 100 for learning purposes. This cultivates children's object recognition and memory through hand-to-eye coordination and allows balanced development of brain.

Although it has been hitherto described that the learning is performed by directly attaching or detaching the learning articles 210 and 220 to or from the wall plate 120, a separate suspension hole 222 may be formed to hang on a suspension piece 300 pre-fabricated on the wall plate 120, as indicated by the second learning article 220. This learning method allows the children to concentrate their attention on the learning article 220 while they suspend the learning article 220 on the suspension piece 300, and to be equipped with object memory.

The suspension piece 300, made of the same material as the wall plate 120, is attachably inserted into each hole 124 formed on the wall plate 120 in a partially protruding state, to provide a suspension unit for easily hanging the second learning article 220 through the suspension hole 222. The suspension piece 300, as shown in FIG. 4, is made of the same nonwoven fabric board as the learning kit body 100, and includes a rectangular body 310 inserted into the wall plate 120 through the hole 124 formed on the wall plate 120. The body 310 may take any shape in addition to the rectangular shape as shown. A narrow, long head 320, forming the suspension unit, is formed at one side of the body, that is, at the upper end viewed from the drawing. The head 320 protrudes outward from the holes 124 of the wall plate 10 to form the suspension unit for suspending the second learning article 2220. The reason of narrowing the width of the head 320 and sharpening the end thereof is to facilitate insertion of the suspension hole 222 with respect to the head 320. A hanging projection 340, protruding toward either side of the head 320, is spaced apart from the body 310. The hanging projection 340 serves to latch the head 320 to the hole 124, without falling into the hole 124 when the suspension piece 300 is inserted into the hole 124 while the body 310 is led into the hole 124 of the wall plate 120, thereby making the head 320 protrude outward with respect to the wall plate 120, providing the suspension unit article 220 for suspending the learning article 220. Since the suspension piece 300 is formed of a nonwoven fabric board having predetermined strength, it is not bent even when the learning article 220 is suspended thereon.

Here, the forms or shapes of the wall plate 120, the three-dimensional article 220 and the learning articles 210 and 220 may be arbitrarily modified and varied, preferably containing shapes materializing the contents of fairy tales by which the children can be motivated by a sense of curiosity and interest.

FIG. 3 is an enlarged cross-sectional view, taken along the line I-I of FIG. 2. The structure of the wall plate 120 of the learning kit body 100 having a cubic effect will now be described with reference to FIG. 3. The wall plate 120 becomes bulky so as to exert a cubic effect by inserting a filler 150 such as fiber offering a cushion-like feeling between at least two nonwoven fabric boards 122a and 122b to then be sewn. The cubic effect, that is, the thickness, of the wall plate 120, can be appropriately adjusted according to the amount of the filler 150. The substrate 110 including the twofold nonwoven boards 112a and 112b, like the wall plate 120, is integrally connected with the wall plate 120 by sewing through a connecting board 130. Also, the hole 124 formed on the wall plate 120 is configured such that the suspension piece 300 is inserted into the wall plate 120, thereby maintaining the suspension pieces to be inserted into and fixed on the wall plate 120.

FIG. 5A is an enlarged perspective view showing the bottom portion of a three-dimensional article shown in FIG. 1, and FIG. 5B is a cross-sectional view, taken along the line II-II of FIG. 5A.

The three-dimensional article 140 has an three-dimensional portion 144 having a cubic effect by inserting a filler 145 such as cotton or chemical fiber between at least two nonwoven fabric boards 142a and 142b to then be sewn. In the three-dimensional article 140, the thickness of the three-dimensional portion 144 can be appropriately adjusted according to the amount of the filler 145 inserted. Also, it is preferred that the amount of the filler 145 does not outreach stitched lines 147 for maintaining balance of the three-dimensional article 140. The reason of forming the three-dimensional portion 144 in the three-dimensional article 140 is to allow children to feel a soft tactile sense when they touch the three-dimensional article 140. A stand 146 of the three-dimensional article 140 is formed by integrally sewing a separately prepared nonwoven fabric with parts of the nonwoven fabric boards 142a and 142b forming the three-dimensional portion 144, thereby maintaining a predetermined strength so as to support the three-dimensional portion 144. also, the bottom of the stand 146 of the three-dimensional article 140 is utilized as a display portion 148 for displaying the name or characteristic of the three-dimensional article 140, thereby having the effect of teaching children.

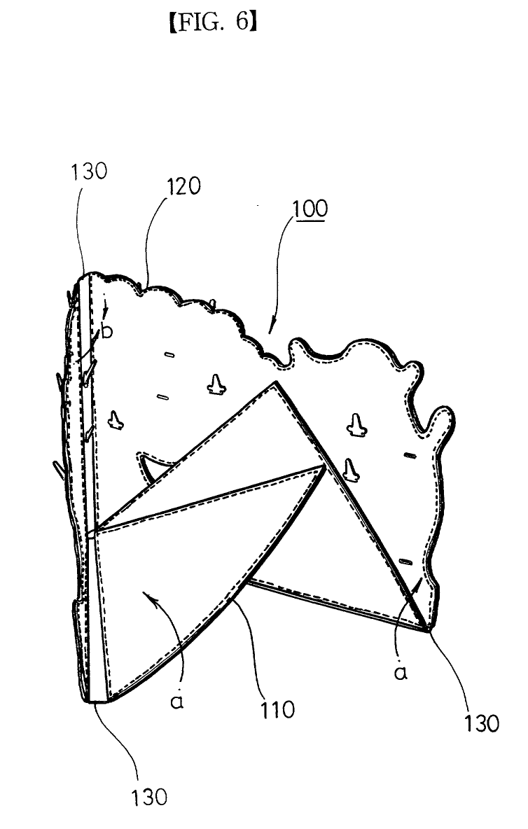

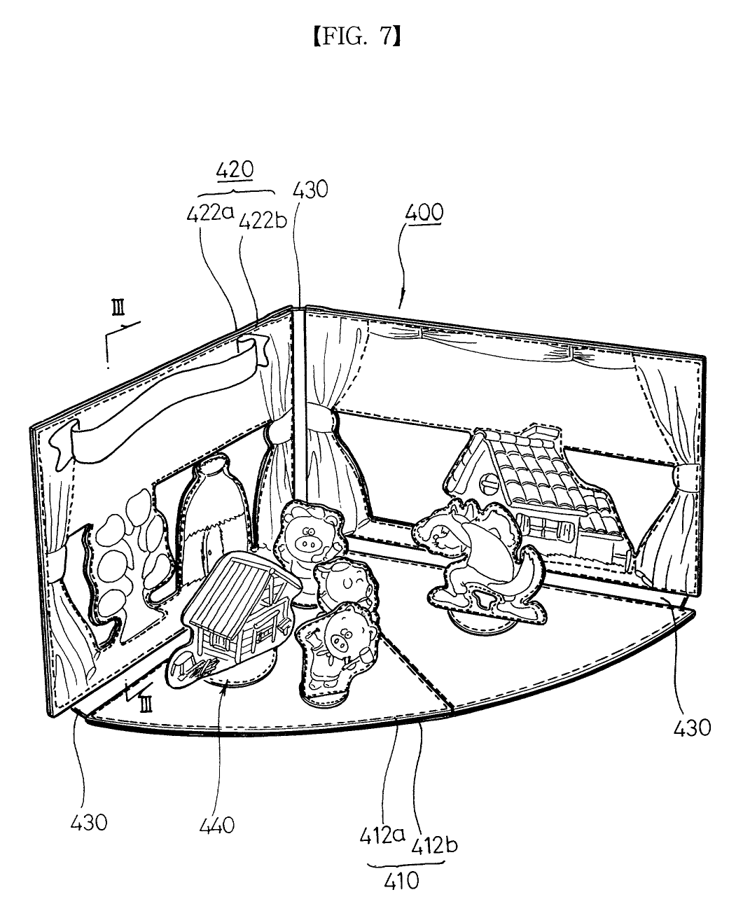

FIG. 6 is a perspective view showing the folded state of the learning kit for three-dimensional play according to the present invention, in which the learning kit 100 is folded to be plate-shaped for conveniently keeping the same when the learning kit 100 is not used. That is to say, the substrate 110, consisting of each being separate boards in the learning kit body 100, is folded in a direction indicated by an arrow “a” through the connecting board 130 so as to be folded toward the wall plate 120. Then, the wall plate 120 next to the substrate 110 is folded in a direction indicated by an arrow “b” through the connecting board 130, so that the learning kit body 100 can be folded in a flattened plate shape. Here, the three-dimensional article 140 or the learning articles 210 and 220 can be put into the folded learning kit body 100 for storage.

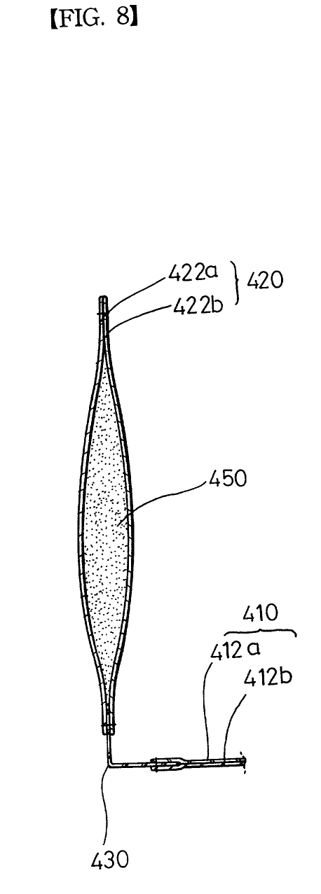

FIG. 7 is a perspective view of a learning kit for three-dimensional play according to another embodiment of the present invention, and FIG. 8 is an enlarged cross-sectional view, taken along the line III-III of FIG. 7.

A learning kit 400 according to this embodiment is the same as that of the above-described embodiment, except that a substrate 410 and a wall plate 420 are constructed based on the contents of a fairly tale titled “The Three Little Pigs”, in view of structure and operation, and a detailed explanation thereof will not be given. In this embodiment, reference numerals 412a and 412b denote two nonwoven fabric boards forming the substrate 410. Also, reference numerals 422a and 442b denote two nonwoven fabric boards forming the wall plate 420, and are filled with a filler 450 giving a cubic effect to then be integrally sewn. Reference numeral 430 denotes connecting boards for connecting the substrate 420 and the wall plate 420, and for connecting the wall plate 420 and another wall plate 420, respectively. As described above, according to the present invention, various objects, animals or plants appearing on fairly tales are constructed by three-dimensional articles, which are substantially real things, so that children are allowed to be acquainted with the development of the contents of the fairly tale while directly moving the three-dimensional articles, thereby evenly cultivating children's brain through utilization of visual, auditory and tactile senses, enhancing object recognition and memory owing to hand-to-eye coordination, and motivating a sense of curiosity for realistic, three-dimensional articles to lead to enhancement in learning effects. Also, since the learning kit is formed using lightweight felt having an adhesive property, safe, durable, easily washable, lightweight properties can be attained. Therefore, children may not be hurt during use of the learning kit, the learning kit is not likely to be damaged by moisture or water, and it can be reused, just by washing even when it becomes dirty.

What is claimed is:

1. A learning kit for three-dimensional play, having a display portion of displaying letters, figures, objects, animals, plants and insects for development of children's ability to learn and intelligence quotient, the learning kit comprising:
a foldable main body having a substrate formed by sewing two or more nonwoven fabric boards cut in predetermined shapes, and wall plates, connected with each other by being vertically mounted at the remaining edge, except a one-side edge, of the substrate with each other, the wall plate having a cubic effect by inserting a fiber between the nonwoven fabric boards cut in divergent shapes of animals, plants or insects and then sewing the same in two folds; and
a plurality of three-dimensional article, being in harmony with various forms displayed on the wall plate, having a three-dimensional portion providing a cubic effect by sewing the articles of shapes of animals, plants or insects cut from the same nonwoven fabric board as the main body in two or more folds and inserting a fiber inside, and a stand, sewed to be leveled at the bottom portion of the three-dimensional portion, for support the same to erect on the substrate, the stand formed of the same nonwoven fabric board as the substrate.

2. The learning kit according to claim 1, further comprising learning articles containing shapes of letters, figures, animals, plants and insects formed of the same nonwoven fabric board as the substrate, and capable of being attached to or detached from the wall plate and substrate.

3. The learning kit according to claim 1 or 2, wherein a suspension means for suspending the learning articles on the wall plate of the main body, the suspension means, having a plurality of holes opened outward with respect to the wall plate, suspension pieces, inserted into the respective holes in an outwardly exposed state, for forming suspension units for suspending the learning articles, and suspension holes formed on the learning articles.

4. The learning kit according to claim 3, wherein each of the suspension pieces comprises:
a rectangular body, formed of the same nonwoven fabric board as the main body, attachably inserted into the wall plate;
a head, protruding outward from the holes of the wall plate to form the suspension unit, the head being long and having a narrow width at one side of the body; and
a hanging projection, protruding toward either side of the head, spaced apart from the body, and latching the head to the hole, without falling into the hole.

5. The learning kit according to claim 1, further comprising a display portion at the bottom of the stand of each of the three-dimensional articles, for displaying the three-dimensional article.

6. The learning kit according to claim 1, wherein the substrate of the main body is formed by at least two separate boards so as to be easily foldable.

7. The learning kit according to claim 1, wherein the nonwoven fabric boards are felt sheets, which are adhesive to each other.
